(19) United States
(12) Patent Application Publication
(10) Pub. No.: US 2022/0214685 A1
(43) Pub. Date: Jul. 7, 2022

(54) REMOTE OPERATING DEVICE

(71) Applicant: IHI Corporation, Tokyo (JP)

(72) Inventors: Masato TANAKA, Tokyo (JP); Shunichi YAMAZAKI, Tokyo (JP); Taku SHIMIZU, Tokyo (JP); Shou YASUI, Tokyo (JP)

(73) Assignee: IHI Corporation, Tokyo (JP)

(21) Appl. No.: 17/598,947

(22) PCT Filed: Mar. 27, 2020
(86) PCT No.: PCT/JP2020/014141

§ 371 Date: Sep. 28, 2021

(30) Foreign Application Priority Data
Mar. 29, 2019 (JP) 2019-067408

(51) Int. Cl. G05D 1/00; G02B 27/00; G02B 27/01; G06T 19/00

(52) U.S. Cl. CPC G05D 1/0044; G05D 1/0038; G05D 1/0016; G02B 2027/0187; G02B 27/0179; G02B 27/017; G06T 19/006; G02B 27/0093

(57) ABSTRACT

A remote operating device includes: a sensor that determines a distance between a movable robot and an object around the movable robot in a worksite; a viewpoint-designating unit that designates a viewpoint for a virtual three-dimensional image of the worksite; a virtual image-generating unit that generates the virtual three-dimensional image based on a determination result of the sensor and the viewpoint designated by the viewpoint-designating unit; a display that displays the virtual three-dimensional image; and an operation unit that generates operation signals for remote operating the movable robot.

### TECHNICAL FIELD

The present disclosure relates to a remote operating device.

Priority is claimed on Japanese Patent Application No. 2019-067408, filed Mar. 29, 2019, the content of which is incorporated herein by reference.

### BACKGROUND

Patent Document 1 below discloses a remote operating device using a manipulator. This remote operating device includes a camera unit that captures images of the workspace of a robot (manipulator), a head-mounted display (HMD) that displays images captured by the camera unit, and a three-dimensional input device that is operated by an operator while the operator watches the images of the head-mounted display, and a robot control computer.

### DOCUMENT OF RELATED ART

### Patent Document

[Patent Document 1] Japanese Unexamined Patent Application, First Publication No. 2000-042960

### SUMMARY

### Technical Problem

In the remote operating device described above, the operator operates the robot by using the three-dimensional input device while the operator watches the camera image of the worksite displayed on the head-mounted display. The camera unit is fixedly installed, and the area (field of view) of the camera image is limited to a fixed area. Therefore, the manipulator may come into contact with, for example, an object that is not shown in the camera image.

The present disclosure is made in view of the above circumstances, and an object thereof is to provide a remote operating device having a variable field of view.

### Solution to Problem

A remote operating device of a first aspect of the present disclosure includes: a sensor that determines a distance between a movable robot and an object around the movable robot in a worksite; a viewpoint-designating unit that designates a viewpoint for a virtual three-dimensional image of the worksite; a virtual image-generating unit that generates the virtual three-dimensional image based on a determination result of the sensor and the viewpoint designated by the viewpoint-designating unit; a display that displays the virtual three-dimensional image; and an operation unit that generates operation signals for remote operating the movable robot.

A second aspect of the present disclosure is that the remote operating device of the first aspect further includes: an image-capturing unit that captures an actual image of the worksite; and an image-compositing unit that composites the virtual three-dimensional image and the actual image to generate a composite image, and the display displays the composite image instead of the virtual three-dimensional image.

A third aspect of the present disclosure is that in the remote operating device of the second aspect, the image-compositing unit adds control information of the movable robot to the composite image.

A fourth aspect of the present disclosure is that in the remote operating device of any one of the first to third aspects, the virtual three-dimensional image includes an object of the movable robot and an object of a workpiece regarded as a work target by the movable robot.

A fifth aspect of the present disclosure is that in the remote operating device of any one of the first to fourth aspects, the display includes a head-mounted display, and the viewpoint-designating unit includes a motion sensor provided in the head-mounted display.

### Effects

According to the present disclosure, it is possible to provide a remote operating device having a variable field of view.

### BRIEF DESCRIPTION OF DRAWINGS

FIG. 1 is a system configuration diagram showing an overall configuration of a robot system of an embodiment of the present disclosure.

FIG. 2 is a block diagram showing a configuration of a remote operating device of the embodiment of the present disclosure.

FIG. 3 is a schematic diagram showing a composite image of the embodiment of the present disclosure.

### DESCRIPTION OF EMBODIMENTS

Hereinafter, an embodiment of the present disclosure is described with reference to the drawings.

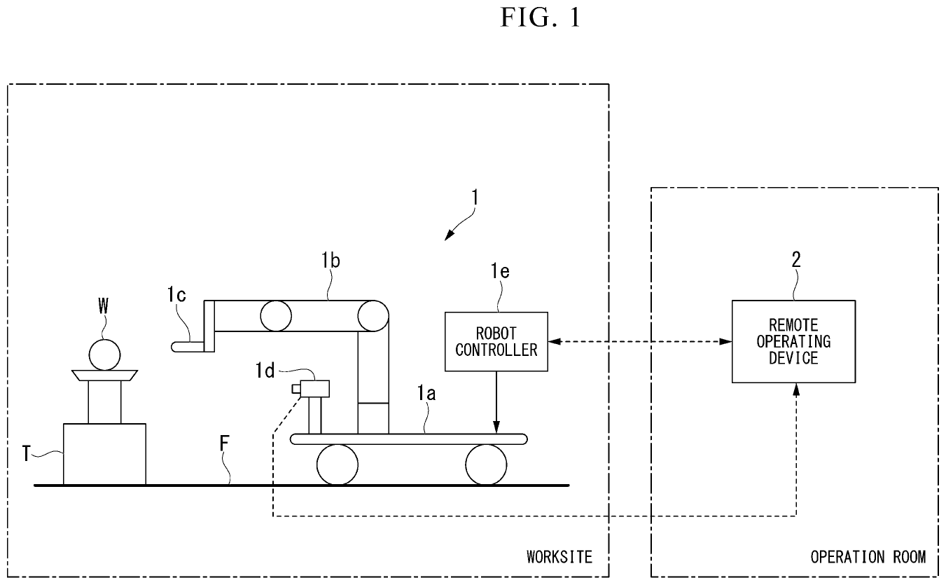

As shown in FIG. 1, a robot system of this embodiment is configured of a robot main body 1 and a remote operating device 2.

The robot main body 1 is an articulated robot that performs predetermined works on a workpiece W while moving in a predetermined worksite (i.e., workspace). As shown in the drawing, the robot main body 1 at least includes a movable cart 1a, a manipulator 1b, a work tool 1c, a sensor 1d and a robot controller 1e. The robot main body 1 corresponds to a movable robot of the present disclosure.

In the worksite, the workpiece W that is a work target of the robot main body 1 is placed on a support stand T. The robot main body 1 performs predetermined works on the workpiece W placed on the support stand T through being controlled by the robot controller 1e.

The movable cart 1a includes wheels and a drive device (motor or the like) that drives the wheels and travels on a floor F of the worksite based on traveling control signals input from the robot controller 1e. The movable cart 1a sets the position of the manipulator 1b mounted on itself in the worksite to a predetermined working position. The structure for the moving of the movable cart 1a is not limited to wheels and may include, for example, caterpillars, walking legs or the like.

The manipulator 1b is fixedly installed in the top of the movable cart 1a and includes arms and joints connecting the arms to each other. Motors provided in the joints are driven based on joint control signals input from the robot controller 1e, whereby the manipulator 1b moves the work tool 1c attached to the tip thereof. That is, the manipulator 1b is a mechanical device that optimally sets the position and posture of the work tool 1c according to working contents to be performed on the workpiece W.

The work tool 1c is detachably attached to the tip of the manipulator 1b and is a portion that directly performs works on the workpiece W. For example, when the workpiece is mechanically machined, the work tool 1c includes a tool that applies a shearing force, a pressing force or the like to the workpiece.

The sensor 1d at least includes a distance sensor and a camera. The sensor 1d is fixedly installed on the front side of the movable cart 1a, that is, in front of the manipulator 1b in the movable cart 1a (i.e., in front of a portion of the manipulator 1b fixed to the movable cart 1a), determines the distance between the robot main body 1 and an object around the robot main body 1 in the worksite, and captures images in front of the movable cart 1a as actual images of the worksite.

“The front side of the movable cart 1a” denotes a side of the movable cart 1a close to the workpiece W during, for example, operations. Alternatively, “the front side of the movable cart 1a” denotes a side (side not to become a blind spot) of the movable cart 1a where the sensor 1d can detect the workpiece W even if the manipulator 1b moves for operations.

The actual image is a moving image showing conditions of the workpiece W in the worksite and of the work tool 1c that performs works on the workpiece. The sensor 1d outputs determination results of the distance with respect to the surrounding object to the remote operating device 2 as distance determination signals and outputs the actual images to the remote operating device 2 as actual image signals.

In FIG. 1, the sensor 1d and the remote operating device 2 are shown as separate components, but the sensor 1d is a component that is functionally included in the remote operating device 2. The sensor 1d corresponds to an image-capturing unit that captures the actual images of the worksite. That is, the camera of the sensor 1d corresponds to the image-capturing unit.

The robot controller 1e is a control device communicatively connected to the remote operating device 2 in an operation room and controls the movable cart 1a and the manipulator 1b based on operation signals received from the remote operating device 2. The robot controller 1e is a kind of computer and processes the operation signals according to control programs stored in advance to control the movable cart 1a and the manipulator 1b according to the operation signals. The computer includes, for example, a CPU (Central Processing Unit), a memory such as a RAM (Random Access Memory) and a ROM (Read Only Memory), and an input/output device that exchanges signals with external devices.

The robot controller 1e transmits pieces of control information of the movable cart 1a and the manipulator 1b to the remote operating device 2. The control information includes, for example, at least one of the operation mode of the robot main body 1, the position of the movable cart 1a, and the angle of each joint of the manipulator 1b.

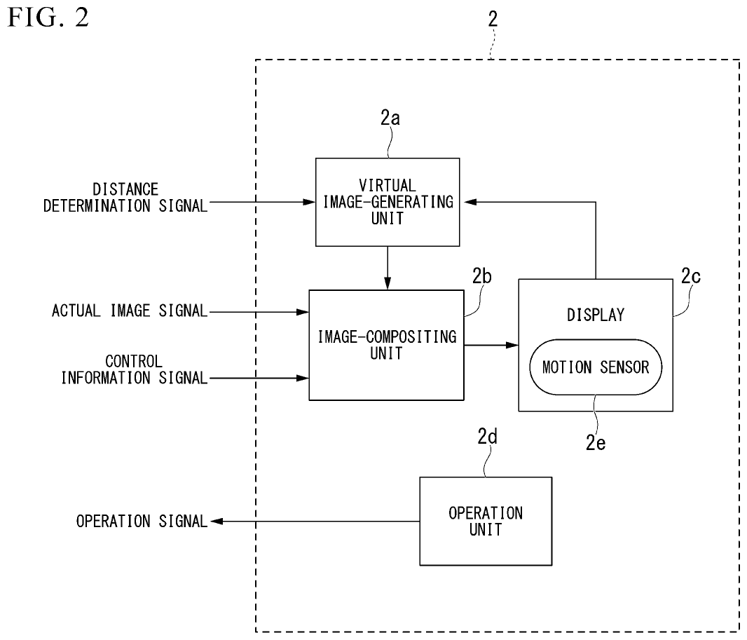

The remote operating device 2 is provided in the operation room away from the worksite and outputs operation signals to the robot main body 1 based on operation inputs from an operator. The remote operating device 2 is a kind of computer that processes the operation inputs based on operation programs to generate operation signals and as shown in FIG. 2, at least includes, as functional components, a virtual image-generating unit 2a, an image-compositing unit 2b, a display 2c and an operation unit 2d.

The remote operating device 2 may include a computer, and the computer may have the functions of the virtual image-generating unit 2a and the image-compositing unit 2b. The computer may include, for example, a CPU (Central Processing Unit), a memory such as a RAM (Random Access Memory) or a ROM (Read Only Memory), and an input/output device that exchanges signals with external devices.

The virtual image-generating unit 2a generates virtual three-dimensional images of the worksite, that is, virtual reality images thereof. That is, the virtual image-generating unit 2a generates virtual three-dimensional images (virtual reality images) of the worksite based on viewpoint-designating signals input from the display 2c described later and distance determination signals input from the sensor (i.e., the distance sensor of the sensor 1d). The virtual three-dimensional image (virtual reality image) at least includes each three-dimensional model (each object) of the workpiece W and the robot main body 1.

In the above virtual three-dimensional image (virtual reality image), a viewpoint thereof is set based on the viewpoint-designating signals. That is, in the virtual three-dimensional image (virtual reality image), the workpiece W, the robot main body 1 and the like are shown as objects viewed from the viewpoint designated by the viewpoint-designating signals. That is, the term “viewpoint” of this embodiment does not include only the meaning of a viewpoint for imaging or visually recognizing an actual object but also includes the meaning of a viewpoint of the generated virtual three-dimensional image.

The image-compositing unit 2b regards the virtual three-dimensional image (virtual reality image) input from the virtual image-generating unit 2a as a basic image and composites, into the virtual three-dimensional image, the actual image of the worksite input from the sensor 1d and the control information of the robot main body 1 input from the robot controller 1e. The image-compositing unit 2b generates a composite image G, in which the virtual three-dimensional image (virtual reality image) is composited with the actual image and the control information, and outputs it to the display 2c.

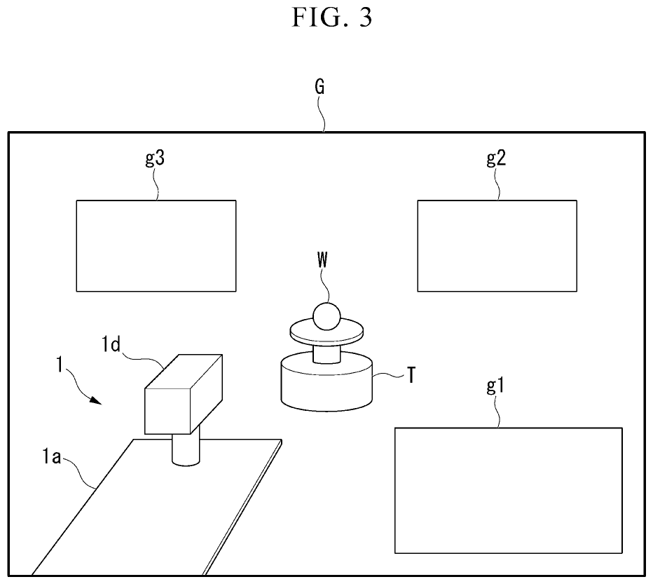

FIG. 3 is a schematic diagram showing an example of the above composite image G. The composite image G is generated by adding an actual image g1 and a control information image g2 to the virtual three-dimensional image (virtual reality image) of the worksite. In the virtual reality image, the workpiece W on the support stand T and the robot main body 1 are shown as objects (objects in the virtual image). In the composite image G, the actual image g1 and the control information image g2 are disposed in areas other than the objects of the workpiece W and the robot main body 1 in the virtual reality image.

The display 2c is a display device that displays the above composite image G. The display 2c provides the composite image G for the operator as support information for remote operating the robot main body 1. That is, the display 2c has a form that is easily visible to the operator in the operation room and is, for example, a head-mounted display (HMD).

In the display 2c, a motion sensor 2e that detects the orientation of the head of a wearer, that is, the operator is provided. The motion sensor 2e outputs detection signals indicating the orientation of the operator's head to the virtual image-generating unit 2a as the viewpoint-designating signals. The motion sensor 2e as described above corresponds to the viewpoint-designating unit that designates a viewpoint of the virtual three-dimensional image (virtual reality image).

The virtual image-generating unit 2a described above obtains detection signals of the motion sensor 2e as the viewpoint-designating signals and thereby generates the virtual three-dimensional image (virtual reality image) having a viewpoint that changes according to the orientation of the operator's head.

The operation unit 2d is a device to which the operator inputs operation instructions. That is, the operation unit 2d receives the operation instructions for remote operating the robot main body 1 from the operator, generates operation signals indicating the operation instructions and outputs the operation signals to the robot controller 1e. The operation unit 2d includes, for example, a joystick.

Next, the operation of the remote operating device of this embodiment is described in more detail.

When remote operating the robot main body 1 using the remote operating device, the operator wears the display 2c that is the HMD on the face thereof and performs operation inputs on the operation unit 2d. That is, the operator performs operation inputs on the operation unit 2d while visually recognizing the composite image G of FIG. 3 by the display 2c to remote operate the robot main body 1.

In such a remote operating environment, when the operator changes the orientation of the head, this change is detected by the motion sensor 2e of the display 2c and is input to the virtual image-generating unit 2a as the viewpoint-designating signal. As a result, the virtual image-generating unit 2a generates the virtual three-dimensional image (virtual reality image) having a viewpoint according to the new head orientation. Then, the virtual three-dimensional image (virtual reality image) having the new viewpoint is input from the virtual image-generating unit 2a to the image-compositing unit 2b.

Then, the image-compositing unit 2b image-composites the actual image and the control information into the virtual three-dimensional image (virtual reality image) having the new viewpoint input from the virtual image-generating unit 2a to generate a new composite image G and outputs the new composite image G to the display 2c. The composite image G having the new viewpoint is generated every time the operator changes the orientation of the head thereof and is displayed on the display 2c.

Then, the operator performs operation inputs on the operation unit 2d by referring as support information for the remote operation to the composite image G having such a new viewpoint. Then, the operation signals according to the operation inputs are input from the operation unit 2d to the robot controller 1e, so that the movable cart 1a, the manipulator 1b and the work tool 1c operate according to the operation inputs. That is, the robot main body 1 is remote operated according to the operation inputs from the operator to the remote operating device 2.

According to this embodiment, when the operator changes the orientation of the head, the viewpoint of objects such as the workpiece W and the robot main body 1 in the composite image G displayed on the display 2c changes, and thus it is possible to provide the remote operating device having a variable field of view. Therefore, according to this embodiment, the operator can more accurately grasp the distance between the workpiece W and the robot main body 1 and the conditions thereof, and thus the workability can be further improved and more accurate operations can be performed than before.

In particular, according to this embodiment, only the object of the robot main body 1 is not displayed on the display 2c but the object of the workpiece W is also displayed on the display 2c as the virtual three-dimensional image (virtual reality image), and thus the operator can more accurately confirm the positional relationship between the robot main body 1 and the workpiece W by changing the viewpoint. Therefore, according to this embodiment, it is possible to provide a remote operating device having further improved workability than before.

Furthermore, according to this embodiment, since the actual image g1 and the control information image g2 are displayed on the display 2c in a state of being added to the virtual three-dimensional image (virtual reality image), the operator can more accurately grasp the conditions of the worksite and the operating state of the robot main body 1. Therefore, according to this embodiment, based on this reason, it is also possible to provide a remote operating device having further improved workability than before.

The present disclosure is not limited to the above embodiment, and for example, the following modifications can be adopted.

(1) In the above embodiment, the actual image g1 and the control information image g2 are added to the virtual three-dimensional image (virtual reality image), but the present disclosure is not limited to this. If it is needed, only the virtual three-dimensional image (virtual reality image) may be displayed on the display 2c. An image in which only the actual image g1 is added to the virtual three-dimensional image (virtual reality image) may be displayed on the display 2c.

The virtual image-generating unit 2a may combine the viewpoint-designating signal input from the display 2c, the distance determination signal input from the sensor 1d, and design information (e.g., CAD data or the like) of the worksite prepared in advance together to generate a virtual three-dimensional image (virtual reality image) of the worksite. If a virtual three-dimensional image, by which the conditions of the worksite can be sufficiently confirmed, can be generated by using the design information of the worksite, the image-compositing unit 2b does not have to composite the virtual three-dimensional image input from the virtual image-generating unit 2a and the actual image of the worksite input from the sensor 1d.

(2) In the above embodiment, the robot main body 1 is configured as a movable robot, but the present disclosure is not limited to this. That is, the present disclosure can also be applied to a robot fixedly installed in the worksite. The present disclosure can also be applied to a worksite where the robot main body 1 is fixedly installed and the workpiece W moves and to another worksite where the robot main body 1 and the workpiece W individually move.

(3) The virtual three-dimensional image (virtual reality image) of the above embodiment at least includes the objects of the workpiece W and the robot main body 1, but the present disclosure is not limited to this. If in the worksite, there are articles needed or important for remote operating the robot main body 1, the articles may also be included as objects in the virtual three-dimensional image (virtual reality image).

(4) In the above embodiment, the head-mounted display (HMD) is adopted as the display 2c, but the present disclosure is not limited to this. For example, the display 2c may include a fixed monitor. The viewpoint-designating unit of the present disclosure is not limited to the motion sensor 2e. For example, the operator may designate the viewpoint of the virtual three-dimensional image (virtual reality image) by operating the operation unit 2d. That is, the viewpoint-designating unit of the present disclosure may include a detector such as a sensor that detects the viewpoint of the operator.

### INDUSTRIAL APPLICABILITY

The present disclosure can be applied to a remote operating device for a movable robot in a worksite and can provide a remote operating device having a variable field of view.

1. A remote operating device, comprising:
a sensor that determines a distance between a movable robot and an object around the movable robot in a worksite;
a viewpoint-designating unit that designates a viewpoint for a virtual three-dimensional image of the worksite;
a virtual image-generating unit that generates the virtual three-dimensional image based on a determination result of the sensor and the viewpoint designated by the viewpoint-designating unit;
a display that displays the virtual three-dimensional image; and
an operation unit that generates operation signals for remote operating the movable robot.

2. The remote operating device according to claim 1, further comprising:
an image-capturing unit that captures an actual image of the worksite; and
an image-compositing unit that composites the virtual three-dimensional image and the actual image to generate a composite image, wherein
the display displays the composite image instead of the virtual three-dimensional image.

3. The remote operating device according to claim 2, wherein
the image-compositing unit adds control information of the movable robot to the composite image.

4. The remote operating device according to claim 1, wherein
the virtual three-dimensional image includes an object of the movable robot and an object of a workpiece regarded as a work target by the movable robot.

5. The remote operating device according to claim 1, wherein
the display includes a head-mounted display, and
the viewpoint-designating unit includes a motion sensor provided in the head-mounted display.
